(19) United States
(12) Patent Application Publication
(10) Pub. No.: US 2021/0182767 A1
(43) Pub. Date: Jun. 17, 2021

(54) SCORING PLATFORM AND ENGINE FOR SOFTWARE ENGINEERING CONTRIBUTIONS

(71) Applicant: PayPal, Inc., San Jose, CA (US)

(72) Inventors: Yash Tibrewala, Chennai (IN); Kushagra Vaish, Chennai (IN); M.A. Manu Needhi, Chennai (IN)

(21) Appl. No.: 16/716,376

(22) Filed: Dec. 16, 2019

(51) Int. Cl. G06Q 10/06; G06F 8/70

(52) U.S. Cl. CPC G06Q 10/063114; G06F 8/70; G06Q 10/06398

(57) ABSTRACT

There are provided systems and methods for a scoring platform and engine for software engineering contributions to a service provider framework. During development of a service provider's framework, such as the software framework used to manage the service provider's servers and network to provide services to other users, various developers may provide contributions to coding and developing the framework. The service provider may provide a platform having a scoring engine that includes multiple scoring rules, which allow the service provider to score the developer's contribution and provide an amount of points in a reward system through intelligent analysis of the completion of the contribution, such as timeliness, quality, and the like. Based on the score, the developer may access a profile and utilize the points to obtain rewards, which may further be posted to the developer's profile.

### TECHNICAL FIELD

The present application generally relates to tracking and management of software engineering, and more specifically to a scoring platform and engine for tracking and managing developer contributions within a service provider framework.

### BACKGROUND

Users may utilize computing devices to perform various actions, including actions with service providers that provide various processes and functionalities to users. For example, applications may allow a user to request, receive, and process data from different services, such as a request for accessing an account and viewing account data, electronically processing a transaction with another device or online platform, and/or requesting data stored in a database. This may further be provided by a framework of the service provider that interacts with client devices to provide these services. When developing applications and the framework of the service provider, developers may perform various actions and provide certain contributions. However, developers are not incentivized to perform certain projects and may avoid certain training. Moreover, developers and managers may not have a quantitative measurement of developer contributions to other developers and be able to provide rewards for particular developer contributions.

### BRIEF DESCRIPTION OF THE DRAWINGS

FIG. 1 is a block diagram of a networked system suitable for implementing the processes described herein, according to an embodiment;

FIG. 2 is an exemplary interface for a gamification system of developer contributions to projects for a software framework of a service provider, according to an embodiment;

FIG. 3 is a block diagram of an exemplary system for gamification of developer contributions to projects of a software framework, according to an embodiment;

FIG. 4 is a flowchart of an exemplary process for a scoring platform and engine for software engineering contributions, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for a scoring platform and engine for software engineering contributions. Systems suitable for practicing methods of the present disclosure are also provided.

A user may utilize an application on a computing device to interact with data services to perform data retrieval, processing, and other service processes, such as online services provided by an online service provider system to perform data processing. This may include accessing and/or authenticating use of an account, performing electronic transaction processing, or otherwise utilizing the data processing services provided by the service provider. During interactions with a service provider, many different actions may be taken, and application programming interfaces (APIs) of different services may be called. This may be done through a framework of the service provider's online platform, such as a software framework that provides different applications, APIs, processes, and the like to integrate with the service provider's hardware servers, devices, and networks. This framework may require development by software developers and engineers, including coding tasks, application development troubleshooting and bug fixing, and other tasks. Moreover, these developers and other engineers may also engage in other activities that benefit the developer with the organization, including training so that the user may better perform certain actions, participation in organization activities that benefit the service provider's organization and/or framework (e.g., recruiting efforts), submission of patent applications related to the developer's activities, and other types of activities further described herein.

When developing, updating, or implementing new functionalities with a framework or otherwise providing other contributions to a service provider or its organization, application developers, coders, administrators, and/or managers may wish to provide scoring, rewards, and other benefits to the developers based on their particular contributions. For example, a developer may perform actions or activities where points may be awarded for performing (including completing) the particular activity based on engineering practices and work, quality of the work or activity, innovation of the activity, self-development of the developer, organizational contributions, or other parameter of the activity. For example, engineering practice points may be associated with contributing to any production repository in the organization and/or framework, reviewing code including that in the production repository, and/or pushing code to the production tool of a repository. The quality of an activity may be scored and points provided based on fixing any live bug and/or providing an improvement to the framework, reporting a new live bug or improvement, and/or writing functional tests in any repository. The innovation points for an activity may be scored based on participating in an internal or external hackathon, winning a prizing in a hackathon, submitting an idea for patent submission or review, and/or having a patent successfully registered, filed, and/or issued. Self-development points may be associated with completing courses with an online platform and/or the service provider, completing online books or video training, participating in internal training programs of the service provider's organization, and/or creating and following a step-up plan. Finally, the organization contribution points may include participating in organizational activities, hosting a session or a workshop for the organization, conducting a meet-up or brown bag session, becoming a mentor or participating in training, and/or sending or receiving accolades for work at the organization.

For each activity, an amount of points, such as “karma” points, may be awarded within a scoring system and platform by a scoring engine. The scoring engine may include rules for the amount of points based on the activity parameters related to engineering practices, quality of the work or activity, innovation of the activity, self-development of the developer, organizational contributions, or other parameter of the activity. For example, adding, deleting, and/or reviewing a set number of lines of code (e.g., ten lines) may be awarded a number of points, such as five points, based on the scoring rules of the scoring engine. Larger or more complicated tasks, such as reviewing larger amounts of code, may be associated with higher numbers of points, e.g., reviewing a product repository that includes 0-25 lines may be afforded ten points, while reviewing a product repository having between 25-150 may correspond to 20 points, and 150-500 lines may correspond to 35 points. The points may be specifically awarded to the developer that completes the task or may be shared between multiple developers or users for tasks completed as a team. The points may be split between the team evenly or based on each developer's contribution to the team's project. For example, the system may identify contributions by individual developers based on tags or identifiers associated with each individual developer and their corresponding work (e.g., a username attached to certain edits or files). A developer may receive points in a profile or account of the developer. Additionally, some rules may allow for removing points from a developer's profile for work that is not completed within the parameters of the particular task or activity. For example, if the activity exceeds its deadline, the developer may lose some points. Similarly, if the developer has a high amount of comments/revisions to their code or develops a large product repository instead of a smaller, more concise, or efficient repository, then the developer may be awarded negative points or have points removed from their profile. The scoring rules may be based on other factors, including those that indicate the activity or task was completed adequately, well, or poorly, and the corresponding points may be awarded based on the level or satisfaction of completing the task by the developer. The scoring rules may also compare specific activities by developers to other activities so that the scoring engine may determine a score for an activity based on comparison to other developers' completion of the activity.

The service provider may provide a platform or portal that is accessible by the developers and managers of the service provider to submit completed work, verifying that a developer has completed a task or activity, link to an external platform that may allow for determination of tasks and activities completed by a developer or other user, and/or view a developer's profile (including redeeming points for rewards and implementing rewards with the user's profile or other online platform). In this regard, the portal may include one or more submission processes for tasks and/or activities of a user. The submission process may allow the developer, manager, or other user to upload the completed activity or otherwise submit documentation of the completed activity, which may then be scored by the service provider's scoring engine and platform, for example, by parsing lines of code or other content of the uploaded documents or files. The submission process may also allow the user to enter the type of activity and other information defining the activity, where a manager may provide their satisfaction rating of the activity, comments regarding the activity, and/or other information necessary to properly score the activity. This may be done through one or more submission fields of a digital document displayed through the interface, including input fields, menu options, and the like. Thus, the portal may also include information for tasks, activities, and other projects established by managers that may be viewed and selected to indicate that a developer has completed some assigned project or has performed an activity. These activities, tasks, and projects may include scoring rules that may be used by the scoring engine to determine a particular score for the developer's work submission when the system reviews the submission.

In some embodiments, the portal may be used to link to an external platform and/or retrieve data from the external platform associated with an activity. For example, a user may utilize another online platform to take a training class or write code for a process or application. The developer may indicate that the activity is completed on the platform, and the portal of the service provider may interface through one or more APIs of the other online platform (e.g., through one or more API calls), which may be used to retrieve information for completion of the activity, including a time until completion, a rating or grade for the completion, data for the project (e.g., lines of code), reviewer comments and/or satisfaction measurement, or other information. The portal may then pull the data from the external platform and may utilize the scoring engine to determine a score for the completion of the activity. The online platform may correspond to a social networking platform, a training service provider, an online repository for coding or other projects, an application used by the service provider or affiliated with the service provider, or other online platform that allows for work on or completion of particular activities associated with the developer's work at the service provider's organization. Additionally, the external platform may allow for different practices to be performed by developers of the service provider and may provide metrics for work on or completion of the practices. For example, the metrics may include tests, completion timers, knowledge assessments, and other quantifiable measurements of the user's completion. Thus, when the service provider's scoring platform pulls the data for the particular activity, the external platform may further provide the metrics that allow the scoring engine to write rules, revise those rules, and/or set points for particular scoring rules and activities.

Once points have been awarded for one or more activities of the developer, the points may be added to a profile for the developer with the service provider's scoring platform. The points may then be redeemed for one or more rewards with the service provider. In some embodiments, the rewards may correspond to digital badges or icons that may be posted to the profile, where the digital badges or icons may include information or data that inform other users of the service provider platform of the point totals, completed activities, or reason for receiving the points. For example, with fifty points, the developer may receive a badge that indicates the user has successfully accrued that many points or completed a number of projects or activities. The badge may also be dynamically generated for the particular developer based on the developer's contributions, reason for receiving points, and/or manager comments on the developer's contributions. Additionally, the rewards, including the graphical badges, may be awarded based on particular scoring benchmarks, total amounts of points, and/or time since using the platform. Where negative points may be awarded for particular activities that are not adequately completed or have negative reviews, badges may be removed if the developer falls below a certain threshold or point total and/or other badges or profile notations may be made based on the number of negative points or reason for reviewing negative points (e.g., a badge or profile review that indicates the developer is chronically late for projects).

Other types of rewards may also be provided to the developer. For example, the developer's score may be used to allow the developer to work on additional projects or access other training or activities. The rewards may also allow the developer to access different processes of the scoring platform, including providing reviews for other developers' work or otherwise reviewing completed activities. The developer may also send points or rewards to other users using the developer's profile. For example, if a project is completed by one developer but had assistance from another developer, the first developer may send an amount of points to the other developer to acknowledge their contribution. As previously discussed, tags or identifiers for certain developers may be attached to their completed work, which may allow managers and developers to identify contributions to a goal or project, and therefore assign an amount of point to those contributors. In some embodiments, the system may automatically perform these identifications and assign points to request the developer to assign points. The developer may also be capable of generating their own tasks and assigning points to the task that other developers may complete. This may include providing points for the completion of the activity from a pool of available points, generating new points for the activity with the digital platform for the service provider, or providing the points for the activity from the developer's account. Thus, the developer may also become a manager for other projects and activities and assign out points for the successful completion of the activity (or remove points based on the unsuccessful or subpar completion). A particular activity may also be provided a pool of points or an excess amount of points, where a manager may assign out additional points to the developer or other developers based on their contributions. In some embodiments, the manager may also be given a set of excess points, which may be renewed or resupplied after a time period, where the manager may assign out additional points for the completion of a particular activity or contribution by a developer that may otherwise have gone unreported.

Once the points have been assigned for the completion of an activity to a user profile, the rewards that the developer has accrued (and/or purchased using the points) may be provided within the developer's profile. The profile may then be viewed by one or more other users, including other developers and/or managers at the service provider's organization. Additionally, notification of the badge, icon, or score may be transmitted to other users at the organization or outside the organization so that the other users may be aware of the developer's contributions. In some embodiments, this may include posting the badge, icon, score, or reward to an external platform, such as a platform of another service provider (e.g., a social networking platform, a job posting and/or recruiting platform, and the like). The service provider's scoring platform may therefore interface with one or more external platforms through an API that allows for a post to be provided for the developer on the other platform. This may include providing a message as well on the other platform.

In this manner, a service provider may provide a digital platform that allows for the service provider to identify, score, and provide rewards for certain engineering contributions to a software framework of the service provider. This allows for the successful software coding, training, and other activities by developers to be properly acknowledged by the service provider. Additionally, this further allows for the service provider to compare specific tasks as well as pull data for tasks completed on other online platforms to recognize contributions of the developers. The gamification system also encourages competition and rewarding of particular software coding activities of the developers. Moreover, through generating and customizing digital icons or other graphical images, the particular contributions may be specifically designated, and the generated icon may be posted to one or more online platforms for viewing by other users over a distributed network

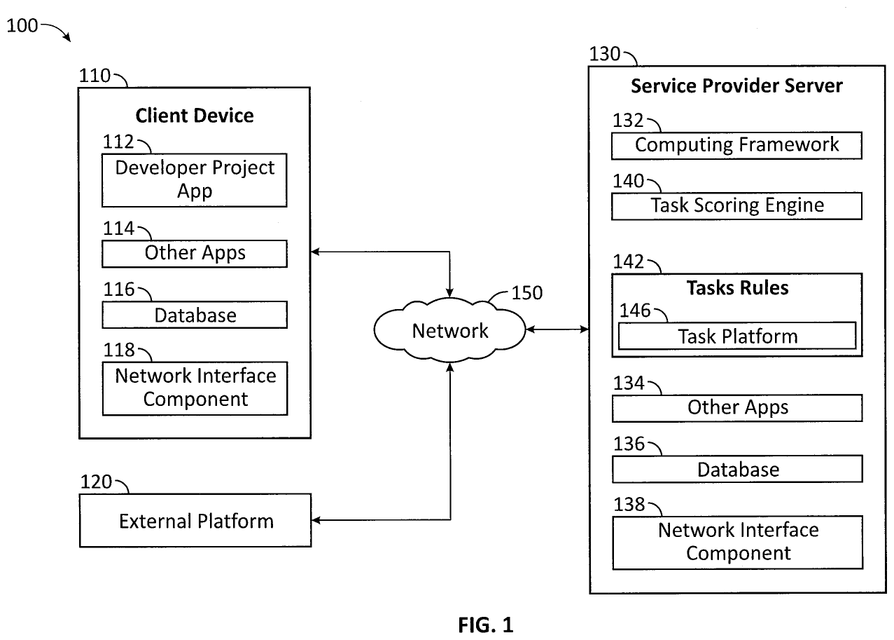

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a client device 110, an external platform 120, and a service provider server 130 in communication over a network 160. A user (not shown) may utilize client device 110 to utilize the various features available for client device 110, which may include processes and/or applications that may interact with services provided by service provider server 130 and/or external platform 120 to complete or work on a task, activity, or project that provides a contribution to the framework of service provider server 130. Note that as used herein, “completion” of a task or other activity/project includes completion of certain stages, milestones, or other measurables of the task or activity/project. Service provider server 130 may provide a scoring platform and engine to assess the particular contribution and provide an amount of points in a reward system with service provider server 130. The data for the contribution may correspond to internal data of service provider server 130 or other data with external platform 120. Once a set of points are awarded, the user's profile with service provider server 130 may receive a reward, which may be posted internally to the profile with the scoring platform and/or to an external account, such as one with external platform 120.

Client device 110, external platform 120, and service provider server 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Client device 110 may be implemented as a computing or communication device that may utilize appropriate hardware and software configured for wired and/or wireless communication with service provider server 130, which may include personal and mobile computing devices of individual and/or groups of customers of service provider server 130, such as single users, merchants, and/or other entities. For example, in one embodiment, client device 110 may be implemented as a personal computer (PC), telephonic device, a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

Client device 110 of FIG. 1 contains a developer project application 112, other applications 114, a database 116, and a network interface component 118. Developer project application 112 and other applications 114 may correspond to executable processes, procedures, and/or applications with associated hardware. In other embodiments, client device 110 may include additional or different modules having specialized hardware and/or software as required.

Developer project application 112 may correspond to one or more processes to execute software modules and associated devices of client device 110 to send, receive, and/or process data with service provider server 130 to facilitate performing a developer project, which may include developer projects with external platform 120 and/or service provider server 130. In this regard, developer project application 112 may correspond to specialized hardware and/or software utilized by a user (e.g., a software developer or other employee, agent, or worker of service provider server 130) of client device 110 to first access a framework for a service provider and/or training materials and projects available with the same or other service providers. Once accessed and running, developer project application 112 may then provide or execute an application within the framework or with the service provider so that one or more developer projects may be performed by the user, including those developer projects associated with engineering practices and work, quality of the work or activity, innovation of the activity, self-development of the developer, organizational contributions, or other parameter of the activity. These tasks, projects, or other work may correspond to development work for the service provider directly, such as adding to, revising, or updating a production repository, reviewing or adding to code, or otherwise assisting is some task. The tasks may also correspond to development of the developer directly or another developer, such as training, recruiting, attending events (e.g., hackathons), winning events or competitions, writing articles, and the like. Thus, client device 110 may also access external platform 120 to perform some project or external platform 120 may be used to track the completion of a task (e.g., hosting or winning a competition or other project that may be tracked).

When the developer project is completed by the developer or reaches a measurable stage, service provider server 130 may determine a score for the project and may update a developer profile based on the scoring, including adding or subtracting points from a point total for the user in the profile, adding, removing, or updating one or more digital badges for the user, and/or otherwise providing a reward or penalty to the user based on completing the task. Developer project application 112 or another application (e.g., a web browser application) may be used to view the developer profile, request certain rewards, and/or use rewards with the reward system for service provider server 130. Developer project application 112 may also be used to interact with the particular developer's score. This may include requesting additional points from a manager, sending points to a co-worker or employee, and/or generating a task for completion and awarding points or setting weights, factors, and parameters for completing and scoring the task by other users.

In various embodiments, client device 110 also includes other applications 114 as may be desired in particular embodiments to provide features to client device 110. For example, other applications 114 may include security applications for implementing client-side security features, programmatic client applications for interfacing with appropriate application programming interfaces (APIs) over network 150, or other types of applications. Other applications 114 may also include additional communication applications, such as email, texting, voice, social networking, and IM applications that allow a user to send and receive emails, calls, texts, and other notifications through network 150. Other applications 114 may be utilized with developer project application 112 to perform and complete a developer task and/or view a developer profile having points and rewards provided based on completing the tasks. Other applications 114 may include device interfaces and other display modules that may receive input and/or output information. For example, other applications 114 may contain software programs, executable by a processor, including a graphical user interface (GUI) configured to provide an interface to the user.

Client device 110 may further include database 116 stored in a transitory and/or non-transitory memory of client device 110, which may store various applications and data and be utilized during execution of various modules of client device 110. Thus, database 116 may include, for example, identifiers (IDs) such as operating system registry entries, cookies associated with voice data application 120 and/or other applications 114, IDs associated with hardware of client device 110, or other appropriate IDs, such as IDs used for payment account/user/device authentication or identification. Database 116 may further include information for developer tasks and/or developer profiles, including account information used to access an account and interact with a developer's profile, awarded points, and rewards.

Client device 110 includes at least one network interface component 118 adapted to communicate with external platform 120 and/or service provider server 130. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Network interface component 118 may communicate directly with nearby devices using short range communications, such as Bluetooth Low Energy, LTE Direct, Wi-Fi, radio frequency, infrared, Bluetooth, and near field communications.

External platform 120 may correspond to a data service, repository, and/or data processing device/server that may be an external resource for performing developer tasks, projects, or other work that assists in developing a service provider, such as service provider server 130. This may include completing projects, such as coding projects and other software development, or assisting in other development, including training and education, recruiting, engaging in competitions, and the like. In this regard, external platform 120 includes one or more processing applications which may be configured to interact with client device 110, service provider server 130, and/or another device/server to provide options for performing developer tasks. In one example, external platform 120 may be provided by PayPal®, GitHub®, LinkedIn®, or another online service provider where one or more users may perform developer tasks. Thus, external platform 120 may be maintained by or include another type of service, which may provide the aforementioned data services for developer tasks, projects, and other work or development for a service provider to a plurality of users. Although only one service is shown, a plurality of services may function similarly.

Service provider server 130 may be maintained, for example, by an online service provider, which may provide payment and other data processing features to users through implemented services of service provider server 130, and may further provide an application testing services through a framework utilizing simulation services. In this regard, service provider server 130 includes one or more processing applications which may be configured to interact with client device 110 and/or another device/server to facilitate application testing. In one example, service provider server 130 may be provided by PayPal®, Inc. of San Jose, Calif., USA. However, in other embodiments, service provider server 130 may be maintained by or include another type of service provider, which may provide the aforementioned services to a plurality of users.

Service provider server 130 of FIG. 1 includes a computing framework 132, a task scoring engine 140, other applications 134, a database 136, and a network interface component 138. Computing framework 132, task scoring engine 140, and other applications 134 may correspond to executable processes, procedures, and/or applications with associated hardware. In other embodiments, service provider server 130 may include additional or different modules having specialized hardware and/or software as required.

Computing framework 132 may correspond to one or more processes to execute software modules and associated specialized hardware of service provider server 130 to provide services to users for data processing and/or performing developer tasks, for example, when users utilizes an application to interact with one or more services of service provider server 130. In some embodiments, computing framework 132 may correspond to specialized hardware and/or software to provide payment services and payment accounts through software services, which may interact with one or more auxiliary services, such as external platform 120. In some embodiments, computing framework 132 may allow for a payment to a user and/or merchant through a payment instrument, including a credit/debit card, banking account, payment account with service provider server 130, and/or other financial instrument. Computing project framework may be used for account services, where a user may generate, access, authenticate, and/or use a payment account and/or other payment services through payment instruments. The user may provide information, including user personal and/or financial information. Additionally, the information may include authentication information, such as a login, account name, password, PIN, or other account creation information. The user may provide a name, address, social security number, or other personal information necessary to establish an account and/or effectuate payments. Computing framework 132 may further allow the user to maintain the payment account, for example, by adding and removing payment instruments. In order to perform transaction processing and/or payments, computing framework 132 may receive and/or generate payment transaction data and process the data through one or more processing stacks and/or services, such as external platform 120. Computing framework 132 may generate a payment instruction and process the payment instruction. Computing framework 132 may also be used to debit an account of the user and provide the payment to an account of the merchant or other user. Computing framework 132 may also be used to provide transaction histories for processed transactions.

Computing framework 132 may be accessed through a device-side application or another application or a device/server. In this regard, the other application and/or computing framework 132 may be tested, developed, and/or updated by developers. For example, production repositories may be updated, changes, edited, or created and added to computing project framework through developer tasks, such as by editing, reviewing, and/or writing lines of code. In some embodiments, computing framework 132 may also be used to perform other tasks, including training tasks, such as taking online courses, reviewing training materials, and/or educating others. Thus, computing framework 132 may be used to performing engineering and development associated with engineering practices and work, quality of the work or activity, innovation of the activity, self-development of the developer, organizational contributions, or other parameter of the activity. Those tasks may then be scored by task scoring engine 140 to add points to a developer profile and/or reward system. The profiles and rewards may be provided by one or more operations, applications, and/or processes provided by computing framework 132. Thus, users, developers, and/or managers may view the points provided by computing project framework, access profiles, and/or exchange or provide points for particular developer tasks. Computing framework 132 may also be used to view, redeem, or utilize rewards based on point totals in developer profiles.

Task scoring engine 140 may correspond to one or more processes to execute software modules and associated specialized hardware of service provider server 130 to provide application testing through a framework that allows services associated with developer tasks, projects, and work to be called so that a “karma” or reward points may be determined and used to add to, update, or remove points from a developer profile of developer, which may be utilized in a reward system of service provider server 130. In this regard, task scoring engine 140 may correspond to specialized hardware and/or software to execute a scoring engine that includes weights, factors, rules, and/or parameters for scoring the completion of a developer task with external platform 120 and/or computing framework 132. For example, rules 142 may be used with tasks 144 to score tasks 144, where rules 142 include rules for rewarding points to completions of developer tasks based on the completion parameters (e.g., time to completion, timeliness, quality, length of project, project review, and/or project importance). Thus, rules 142 may be used to score tasks 144, where the score may be based on a time to completion, quality of completion, completed items or tasks, reviews by other users, and/or other parameter that may be detected for the completion of the task. Rules 142 and corresponding points may also be separated based on a project type or “karma” type for the completion of tasks 144, as well as implementation details of rules 142 so that the points may be specifically calculated by project scoring engine. Exemplary rules, points, point/project type, and/or rule implementations are shown in the following tables.

TABLE 1
Developer Rules

| S. | | Karma | Karma | Rule |
|---|---|---|---|---|
| No. | Rule | Points | Type | Implementation |
| 1 | Have a Pull Request Merged | 5 to 50 | Engineering | Lines Added + Lines Deleted = |
| | (Depending on Lines of Change) | | Practices | Size of Pull Request |
| 2 | Write one Functional Test | 5 | Quality | Functional Tests Added = number of |
| | | | | testng @Test Annotations in Lines Added |
| | | | | Functional Tests Deleted = number |
| | | | | of testng @Test Annotations in Lines Deleted |
| | | | | Net New Functional Tests = Functional |
| | | | | Tests Added − Functional Tests Deleted |
| | | | | Points = Net New Functional |
| | | | | Tests * Multiplier |
| | | | | Multiplier = 5 |
| 3 | Increase Unit Test Coverage | 10 | Engineering | Line or Branch Coverage of Unit Tests |
| | by 1% | | Practices | Increased by 1% |
| 4 | Delete 10 Lines of Code | 0-100 | Engineering | Net Lines Deleted = Lines |
| | | | Practices | Deleted − Lines Added |
| | | | | Points = Net Lines Deleted * Multiplier |
| | | | | Multiplier = 0.5 |
| | | | | Mininmum Points = 0 |
| | | | | Maximum Points = 100 |
| 5 | Have a JIRA Ticket Associated | 5 | Engineering | Title Contains a JIRA Issue Id |
| | with Pull Request | | Practices | |
| 6 | Add Self Review Comments | 2-5 | Engineering | Add self review |
| | | | Practices | comments on the pull |
| | | | | request to explain the |
| | | | | code. |
| 7 | Have Low Review-Comments for | 5 | Engineering | Comment Ratio = Total number of |
| | Size of Pull Request | | Practices | comments/size of pull request |
| | | | | Threshold Values − |
| | | | | Size of Pull Request ∈ [0, 25) − Not |
| | | | | Considered Lines of Change ∈ [25, |
| | | | | 250] − ratio ∈ [0, 0.02] Lines of |
| | | | | Change ∈ (250, ∞) − ratio ∈ [0, |
| | | | | 0.01] |
| 8 | Have High Review-Comments for | −5 | Engineering | Comment Ratio = Total number of |
| | Size of Pull Request | | Practices | comments/(pr. additions + pr. deletions) |
| | | | | Threshold Values − |
| | | | | Lines of Change ∈ [0, 25) − Not |
| | | | | Considered Lines of Change ∈ [25, |
| | | | | 250] − ratio ∈ [0.05, ∞) Lines of |
| | | | | Change ∈ (250, ∞) − ratio ∈ [0.025, |
| | | | | ∞) |
| 9 | Fix an Issue which was cuasing | 50 | Engineering | Has a label containing the string FCI |
| | Failed Customer Interactions (FCI) | | Practices | |
| 10 | Create a Small Pull Request | 5 | Engineering | Size of PR = pr. additions + pr. deletions |
| | | | Practices | Size of PR ∈ [0, 250] |
| 11 | Create a Large Pull Request | −5 to −10 | Engineering | Size of PR = pr. additions + pr. deletions |
| | | | Practices | Threshold Values |
| | | | | Size of PR ∈ (500, 2500] − −5 |
| | | | | Karma Points Size of PR ∈ |
| | | | | (2500, ∞) - −10 Karma Points |
| 12 | Pull Request Merged within | 5 | Engineering | Number of Days Open = Closed At − Created At |
| | 3 Days | | Practices | Number of Days Open ∈ [0, 3] |
| 13 | Pull Request Open for Too | −5 to −40 | Engineering | Number of Days Open ∈ (7, 14] - −5 Karma |
| | Many Days | | Practices | Points |
| | | | | Number of Days Open ∈ (14, 30] - −10 Karma |
| | | | | Points |
| | | | | Number of Days Open ∈ (30, 60] - −20 Karma |
| | | | | Points |
| | | | | Number of Days Open ∈ (60, ∞) - −40 Karma |
| | | | | Points |
| 14 | Pull Request Has Few Commits | 5 | Engineering | Number of Commits on Pull Request <= 3 |
| | | | Practices | |
| 15 | Pull Request Has Too Many Commit | −5 to −10 | Engineering | Number of Commits ∈ (3, 10] - −5 Karma |
| | | | Practices | Points |
| | | | | Number of Commits ∈ (10, °°) - −10 Karma |
| | | | | Points |

TABLE 2
Reviewer Rules

| S. | | Karma | Karma | Rule |
|---|---|---|---|---|
| No. | Rule | Points | Type | Implementation |
| 1 | Review a PR (Between 0 | 10 | Engineering | Lines Added + Lines Deleted = |
| | and 25 Lines) | | Practices | Size of Pull Request |
| | | | | Size of Pull Request ∈ (0, 25] |
| 2 | Review a PR (Between 25 | 20 | Engineering | Lines Added + Lines Deleted = |
| | and 150 Lines) | | Practices | Size of Pull Request |
| | | | | Size of Pull Request ∈ (25, 150] |
| 3 | Review a PR (Between 150 | 35 | Engineering | Lines Added + Lines Deleted = |
| | and 500 Lines) | | Practices | Size of Pull Request |
| | | | | Size of Pull Request ∈ |
| | | | | (150, 500]] |
| 4 | Review a PR (More than 500 Lines) | 50 | Engineering | Lines Added + Lines Deleted = |
| | | | Practices | Size of Pull Request |
| | | | | Size of Pull Request ∈ (500, ∞) |
| 5 | Review PR within One Day | 5 | Engineering | Time Taken to Review Pull Request = |
| | | | Practices | Assigned Time − Review Submission Time |
| | | | | Time Taken to Review Pull Request ∈ |
| | | | | [0, 24] hours |
| 6 | Take Too Long to Review PR | −10 | Engineering | Time Taken to Review Pull Request = |
| | (3 to 7 Days) | | Practices | Assigned Time − Review Submission Time |
| | | | | Time Taken to Review Pull Request ∈ |
| | | | | (72,, ∞) hours |

TABLE 3
Jira Rules

| S. | | Karma | Karma | Rule |
|---|---|---|---|---|
| No. | Rules | Points | Type | Implementation |
| 1 | Fix a P0/P1 Open on Live Bug | 125 | Quality | Priority - P0, P1 |
| | | | | Issue Type - Bug, Security Vulnerability |
| | | | | Environment - Live, Sandbox |
| | | | | Resolution - Fixed, Completed, Accepted |
| 2 | Fix a P2 Open on Live Bug | 175 | Quality | Priority - P2 |
| | | | | Issue Type - Bug, Security Vulnerability |
| | | | | Environment - Live, Sandbox |
| | | | | Resolution - Fixed, Completed, Accepted |
| 3 | Fix a P3/P4 Open on Live Bug | 250 | Quality | Priority - P3, P4 |
| | | | | Issue Type - Bug, Security Vulnerability |
| | | | | Environment - Live, Sandbox |
| | | | | Resolution - Fixed, Completed, Accepted |
| 4 | Fix a Non-Live Bug | 75 | Quality | Priority - Any |
| | | | | Type - Bug, Security Vulnerability |
| | | | | Environment - ! (Live, Sandbox) |
| | | | | Resolution - Fixed, Completed, Accepted |
| 5 | Fix an FCI Improvement | 75 | Quality | Priority - Any |
| | | | | Issue Type - Improvement, Task |
| | | | | Label - At least one Contains “FCI” |
| | | | | Environment - Any |
| | | | | Resolution - Fixed, Completed, Accepted |
| 6 | Fix an Improvement | 5 | Quality | Priority - Any |
| | | | | Issue Type - Improvement, Task |
| | | | | Environment - Any |
| | | | | Resolution - Fixed, Completed, Accepted |
| 7 | Report a P0/P1 Live Bug | 25 | Quality | Priority - P0, P1 |
| | | | | Issue Type - Bug, Security Vulnerability |
| | | | | Environment - Live, Sandbox |
| 8 | Report a P2 Live Bug | 35 | Quality | Priority - P2 |
| | | | | Issue Type - Bug, Security Vulnerability |
| | | | | Environment - Live, Sandbox |
| 9 | Report a P3/P4 Live Bug | 50 | Quality | Priority - P3, P4 |
| | | | | Issue Type - Bug, Security Vulnerability |
| | | | | Environment - Live, Sandbox |
| 10 | Report a Non-Live Bug | 15 | Quality | Priority - P0, P1 |
| | | | | Issue Type - Bug, Security Vulnerability |
| | | | | Environment - ! (Live, Sandbox) |
| 11 | Report an FCI Improvement | 25 | Quality | Priority - Any |
| | | | | Issue Type - Improvement, Task |
| | | | | Label - At least one Contains “FCI” |
| | | | | Environment - Any |
| 12 | Report an Improvement | 5 | Quality | Priority - Any |
| | | | | Issue Type - Improvement, Task |
| | | | | Environment - Any |
| 13 | Close an OOL Bug with Resolution Other | 50 | Quality | Priority - Any |
| | than Fixed (eg: - Won't Fix) | | | Issue Type - Bug, Security Vulnerability |
| | | | | Environment - Live, Sandbox |
| | | | | Resolution - ! (Fixed, Completed, Accepted) |
| 14 | Solve Bug within SLA | 10 | Quality | Bug Solve Duration = Code Completion Time - |
| | | | | Bug Assignment Time |
| | | | | Priority = P0 ⇒ Bug Solve Duration <= 2 Days |
| | | | | Priority = P1 ⇒ Bug Solve Duration <= 4 Days |
| | | | | Priority = P2 ⇒ Bug Solve Duration <= 7 Days |
| | | | | Priority = P3/P4 ⇒ Bug Solve Duration <= 14 |
| | | | | Days |
| 15 | Triage a Bug | 5 | Quality | Add a Comment on OOL Jira |
| | | | | Priority - Any |
| | | | | Type - Bug, Security Vulnerability |
| | | | | Environment - Live, Sandbox |

TABLE 4
Deployment Rules

| S. | | Karma | Karma | Rule |
|---|---|---|---|---|
| No. | Rules | Points | Type | Implementation |
| 1 | Push an Altus Component | 100 | Engineering | Service Now Change Ticket |
| | to Production | | Practices | Triggered for Full |
| | | | | Rollout of Component (eg: - |
| | | | | txnfulfillmentserv) by User |
| 2 | Ramp new Config Through | 20 | Engineering | Service Now Change Ticket |
| | RCS | | Practices | Triggered for Config |
| | | | | Change of Component (eg: - |
| | | | | txnfulfillmentserv) by User |
| 3 | Live Test One Box for Altus | 20 | Engineering | Service Now Change Ticket |
| | Component | | Practices | Triggered for Live |
| | | | | Testing of Component (eg: - |
| | | | | txnfulfillmentserv) by User |
| 4 | Live Test One Box for Altus | 100 | Quality | Service Now Change Ticket |
| | Component and Rollback? | | | Triggered for Live |
| | | | | Testing of Component (eg: - |
| | | | | txnfulillmnetserv) and No Full |
| | | | | Rollout in Next 24 Hours |
| 5 | Rollback of Altus Component | −50 | Engineering | Service Now Ticket for |
| | (Due to External Contact) | | Practices | Rollback of Manifest |

TABLE 5
Confluence Rules

| S. | | Karma | Karma | Rule |
|---|---|---|---|---|
| No. | Rules | Points | Type | Implementation |
| 1 | Create a New | 100 | Engineering | Create a New Confluence Page in |
| | Confluence Page | | Practices | One of the Relevant Spaces |
| | | | | eg: - PAYM |

TABLE 6
Self-Development Rules

| S. | | Karma | Karma | Rule |
|---|---|---|---|---|
| No. | Rules | Points | Type | Implementation |
| 1 | Complete one Course on | 50 | Self | Computer Science Related Course Marked |
| | LinkedIn Learning | | Development | as Completed on LinkedInLearning |
| 2 | Complete one Book or Video | 50 | Self | Computer Science Related Book or Video |
| | Lecture on O'Reilly | | Development | Lecture Marked as Completed on O'Reilly |
| | Books Online | | | Books Online |

Tasks 144 may be associated with task platform 146 that the project is completed on, where task platform 146 is required to be accessed to determine scores for tasks 144 based on rules 142. Thus, these factors, parameters, and weights used to determine a score by task scoring engine 140 may also be based on data determined from external platform 120 when task platform 146 indicates the task was completed on an external platform. For example, an API of task scoring engine 140 may be used to determine data and completion information for the task with external platform 120, including comparing the developer's completion of the task to other users. External platform 120 may correspond to a plurality of different individual platforms, where each of those platforms may be parsed or data requested through the API of task scoring engine 140. Thus, multiple different developer platforms associated with external platform 120 may be utilized to determine whether to assign points, deduct points, or not assign any points based on rules 142. Once task scoring engine 140 has determined the points for a particular developer task or project, the points may be awarded to a developer profile for the corresponding developer that completed the task. Thus, task scoring engine 140 may interface with one or more APIs of a scoring, reward, and profile system of computing framework 132 to update a profile based on the determined points. Moreover, task scoring engine 140, or the reward platform of computing framework 132, may be used to provide a reward, such as a digital badge, update a previously provided reward, and/or otherwise generate a graphical badge or object that identifies the points and/or successful completion of a task.

In various embodiments, service provider server 130 includes other applications 134 as may be desired in particular embodiments to provide features to service provider server 130. For example, other applications 134 may include security applications for implementing server-side security features, programmatic client applications for interfacing with appropriate application programming interfaces (APIs) over network 150, or other types of applications. Other applications 134 may contain software programs, executable by a processor, including a graphical user interface (GUI), configured to provide an interface to the user when accessing service provider server 130, where the user or other users may interact with the GUI to more easily view and communicate information. In various embodiments, other applications 134 may include connection and/or communication applications, which may be utilized to communicate information to over network 160.

Additionally, service provider server 130 includes database 136. As previously discussed, a user may establish one or more digital wallets and/or payment accounts with service provider server 130. Digital wallets and/or payment accounts in database 136 may include user information, such as name, address, birth date, payment instruments/funding sources, additional user financial information, user preferences, and/or other desired user data. Users may link to their respective digital wallets and/or payment accounts through an account, user, and/or device identifier. Thus, when an identifier is transmitted to service provider server 130, e.g., from client device 110, one or more digital wallets and/or payment accounts belonging to the users may be found. Database 136 may also store information for task scoring engine 140, including data for point rules and scoring, as well as developer profiles having point totals and rewards (e.g., digital badges that may be generated, updated, or provided based on a developer's point total).

In various embodiments, service provider server 130 includes at least one network interface component 138 adapted to communicate client device 110, external platform 120, and/or other devices/servers over network 160. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

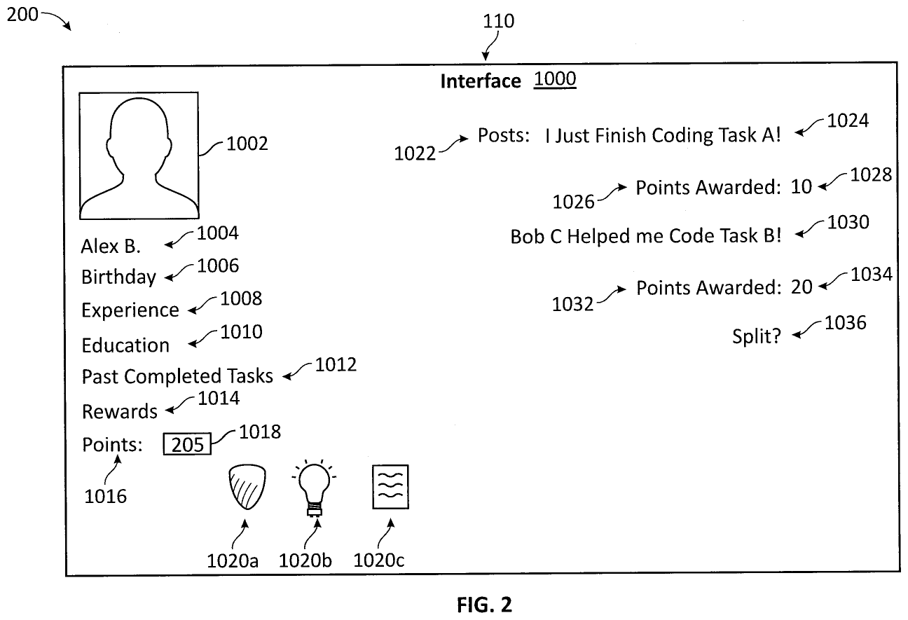

FIG. 2 is an exemplary interface for a gamification system of developer contributions to projects for a software framework of a service provider, according to an embodiment. Environment 200 of FIG. 2 includes client device 110 discussed in reference to system 100 of FIG. 1, where client device 110 may display an interface for an application that may access a user profile for a user, such as a developer, employee, and/or manager of a service provider. In this regard, the profile may include points and rewards provided to the developer by a task scoring engine and service provider system, such as those functions and processes provided by service provider server 130 in system 100.

For example, an interface 1000 includes the profile for the developer or other user, which may be accessible through a website, native device application, or other online portal and/or resource for social networking, profile monitoring and use, employment services, and/or rewarding users to completing tasks and other work for a service provider. Thus, interface 1000 corresponds to a particular developer's profile, which may correspond to a developer image 1002 for a developer 1004 shown as Alex B. Developer 1004 may further have profile information, such as a birthday 1006, experience 1008 of developer 1004 (e.g., work history, such as a resume, as well as other experience including training the user has completed, teams the user has worked on, and the like), and/or an education 1010 of developer 1004. Moreover, the profile further includes past completed tasks 1012, such as developer tasks the user has completed with a particular employer. Past completed tasks 1012 may correspond to those tasks completed with a particular employer, or shared between multiple employers where the reward system may also be shared, that are scored by a scoring engine and added to available points and rewards within the profile of the developer.

For example, past completed tasks 1012 may be scored based on one or more rules, weights, and/or factors for scoring of the tasks. This may result in rewards 1014 that are provided to the developer's profile based on completing the tasks and scoring those tasks. A point total 1016 may include all points awarded to the developer's profile based on past completed tasks. Points 1018 for point total 1016 show 205 points available and/or awarded to the user in the user's profile. These points may be available to redeem for rewards or may cause the automatic awarding of certain rewards. For example, one or more digital badges may be provided to the profile, which may be generated, customized, or provided from stock badges based on points 1018. In this regard, a badge 1020a, a badge 1020b, and a badge 1020c may have each been awarded based on completing a task, an amount of points for completing the task or the same or similar tasks, and/or points 1018 accumulated in the profile. Each badge may have a different meaning and each badge may be specifically customized for the specific task or point total. For example, badge 1020a may have been awarded for work in protecting a service provider's infrastructure, such as by finding and fixing a bug or exploit, removing malware or viruses, protecting from external threats, or the like. Badge 1020b may be awarded for an innovation task, such as filing an idea disclosure for a patent, obtaining a patent application filing, or otherwise providing some innovative material to the service provider. Badge 1020c may have been awarded for winning a competition or writing a published article.

The developer's profile may also be used to post updates and/or allow the developer to post data, including messages, media, and other content that may be viewed by other users. In this regard, interface 1000 further shows posts 1022 that may be provided on the developer's profile. A first post 1024 shows a message of “I just finished coding task A!” First post 1024 further includes awarded points 1026 of 10 points 1028. These points may be awarded based on a scoring engine weighing the completion parameters of the task using a set of rules. Further, a second post 1030 shows a message of “Bob C helped me code task B!” Second post 1030 includes awarded points 132 of 20 points 1034. However, as second post 1030 notes that two employees or developers worked together on task B, the profile further allows for a split option 1036 to provide an amount of points to Bob C, which may correspond to additional points that the user has already received or is sharing for task B.

In some embodiments, the developer's profile in FIG. 2 may correspond to or include a manager's or administrator's profile that may be displayed through the same or a similar interface. The manager's profile may include additional interface elements that allow for the manager to perform additional functionalities. For example, the manager may be able to view a leaderboard of points for his team and rewards earned by his team. This leaderboard may also provide functionality for the manager to assign points and/or awards to developers within the leaderboard or other developers in the system. In some embodiments, when viewing rewards 1014 and/or points 1018, the developer and/or manager may be able to assign and/or award points to other developers, such as based on past completed tasks 1012 and/or the leaderboard of developers. In some embodiments, badges 1020a-c may also be assigned.

The manager's profile, as viewed through a user interface, may also allow the manager to adjust points and/or rules for awarding points. For example, the manager's profile may further include an interface element to select currently pending tasks and/or past completed tasks 1012. When viewing tasks or projects under these specific tabs after selecting the corresponding interface element, the manager may view rules and awards (or pending to be awarded) points for completing certain portions, tasks, or other steps of a project. The manager may adjust such rules and point award totals based on changes to the tasks or projects, as well as changes to working developers, their work, or other details of the task. The rule changes may also automatically reconfigure and change the awarded points (e.g., apply retroactively by the scoring engine), or may only adjust further awarding of points.

Moreover, the manager's profile may also be utilized to view posts 1022 from one or more developers, as well as the developers' contributions on one or more external platforms. For example, a task scoring engine may parse or retrieve data from multiple external platforms where developers may engage in coding, learning, or other tasks that contribute to an organization. The task scoring engine may populate those completions as posts 1022 or other data in the manager's profile so that the manager may view the tasks that their developers are engaged in or have completed. Moreover, the manager's profile may include a user interface that automatically performs a scrape, API calls and requests, and/or parsing of developer data (e.g., developer profiles and tasks) completed on the other external platforms so that the manager may view the status of pending tasks.

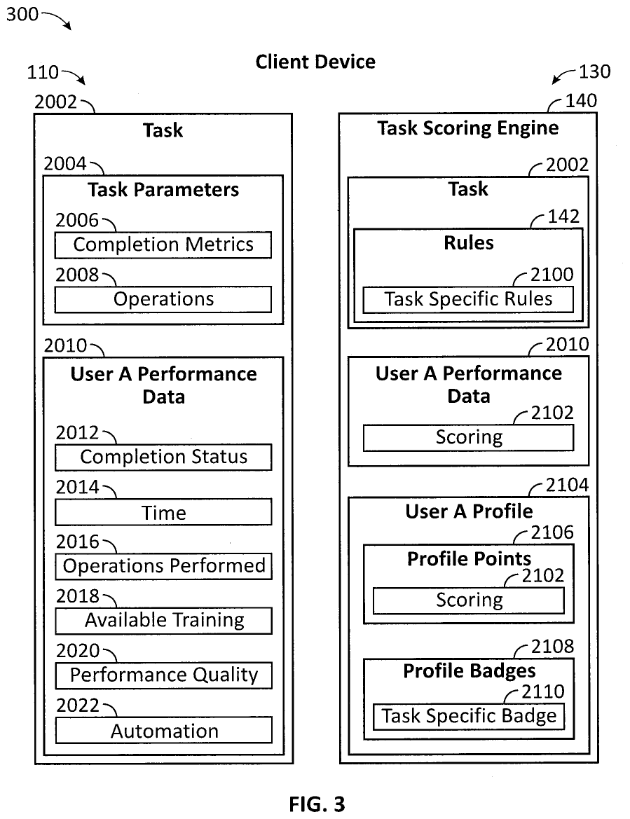

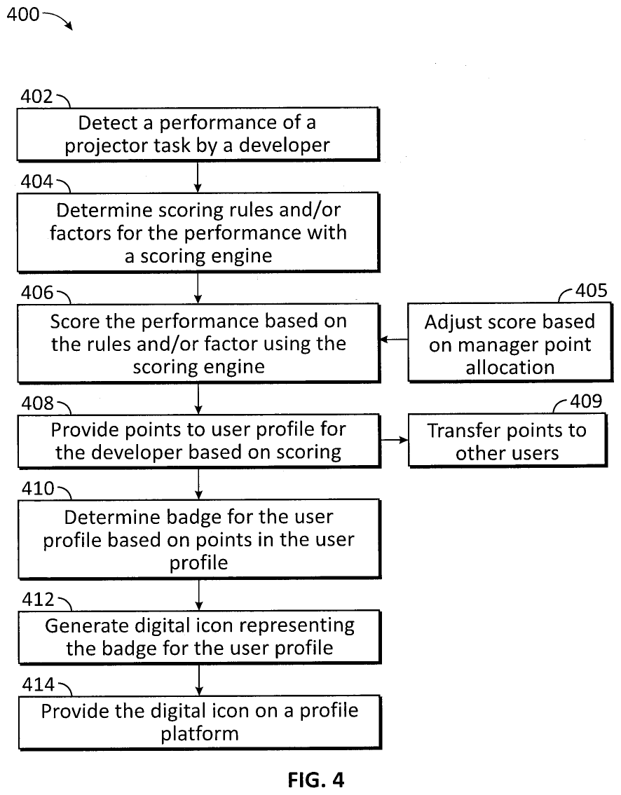

FIG. 3 is a block diagram of an exemplary system for gamification of developer contributions to projects of a software framework, according to an embodiment. Environment 300 includes client device 110 and service provider server 130 discussed in reference to system 100 of FIG. 1. Thus, client device 110 and service provider server 130 interact to perform scoring of task completion and updating a developer's profile based on the scoring using the various processes and features discussed in reference to system 100. This may then be utilized to perform developer task scoring through a process or flowchart, as discussed in reference to FIG. 4.

Client device 110 displays a task 2002 which may be output by an application accessing and/or utilizing a framework available with service provider server 130, such as a computing framework that may be updated, added to, or otherwise developed by employees of a service provider. In some embodiments, task 2002 may instead or also correspond to a task with an external service provider and/or may include tasks for developer development, such as training, recruiting, and the like. Task 2002 being performed and/or completed on client device 110 may further include task parameters 2004 that need to be performed and/or completed by the developer when completing task 2002, and may further be evaluated for quality, timeliness, or other scoring rule factors. For example, task parameters 2004 may be measured by completion metrics 2006 for operations 2008. With task 2002, user A performance data 2010 may be accrued and provided for scoring task completions for a profile of the developer corresponding to client device 110. In this regard, user A performance data 2010 includes a completion status 2012 for task 2002, a time 2014 that task 2002 was completed in or by (e.g., completion date), operations performed 2016 by the developer during the completion of task 2002, available training 2018 completed or performed by the developer, performance quality 2020 of the developer's performance of task 2002, and/or an automation 2022 availability of automating operations or goals for task 2002.

Service provider server 130 therefore provides a task scoring engine 140, which may be used to score a developer task completed by a developer. For example, in environment 300, task scoring engine 140 may score task 2002 using rules 142, which may include rules associated with particular tasks for engineering practices and work, quality of the work or activity, innovation of the activity, self-development of the developer, organizational contributions, or other parameter of the activity. A task associated with engineering practice points may include contributing to any production repository in the organization and/or framework, reviewing code including that in the production repository, and/or pushing code to the production tool of a repository. A quality task may be scored and points provided based on fixing any live bug and/or providing an improvement to the framework, reporting a new live bug or improvement, and/or writing functional tests in any repository. The innovation points for a task may be scored based on participating in an internal or external hackathon, winning a prize in a hackathon, submitting an idea for patent submission or review, and/or having a patent successfully registered, filed, and/or issued. Self-development points may be associated with tasks for completing courses with an online platform and/or the service provider, completing online books or video training, participating in internal training programs of the service provider's organization, and/or creating and following a step-up plan. Finally, the organization contribution points for a task may include participating in organizational activities, hosting a session or a workshop for the organization, conducting a meet-up or brown bag session, becoming a mentor or participating in training, and/or sending or receiving accolades for work at the organization.

Rules 142 may also include task specific rules 2100 of those above tasks and rules for scoring particular tasks. After pulling user A performance data 2010 from an internal or external database that stores completion parameters for task 2002, user A performance data 2010 may be processed by task scoring engine 140 based on rules 142 so as to generate scoring 2102 for task 2002. Scoring 2102 may include some karma points or other rating of performance of task 2002 by the developer. Scoring 2102 may then be added to a user A profile 2104, where profile points 2106 may include scoring 2102 of task 2002, as well as other points, karma, or other reward for completions of other tasks. Using profile points 2106, profile badges 2108 may be awarded, redeemed, updated, and/or otherwise obtained for the developer's profile. Profile badges 2108 may be general for profile points 2106 or may include task specific badge 2110 based on the completion specifically of task 2002.

FIG. 4 is a flowchart of an exemplary process for a scoring platform and engine for software engineering contributions, according to an embodiment. Note that one or more steps, processes, and methods described herein of flowchart 400 may be omitted, performed in a different sequence, or combined as desired or appropriate.

At step 402 of flowchart 400, a performance of a project or task by a developer is detected. The performance may be detected through completion of an internal task of a service provider, such as when a developer completes a project, training, competition, or other required or optional work with the service provider. The performance may also be detected from completion of data with another external service provider. For example, completion of a task may be sent to the service provider for scoring or made available to the service provider. Detection of a completion of the project or task may be done without user input, such as when a server or computing device detects code has been debugged, a bug has been removed, a process now requires less time to complete, a routine or sub-routine can be executed without errors, and other results only machines can determine through software changes.

The developer may request the data to be scored, where the performance data may then be retrieved. Using the performance, scoring rules and/or factors for the performance with a scoring engine is determined, at step 404. These rules and/or factors may correspond to weights and other information used to score a particular performance of a task based on the completion of the task, where the scoring may correspond to points or other value, such as “karma,” provided to users for completing the task.

Thereafter, the performance is scored based on the rules and/or factors using the scoring engine, at step 406. The scoring corresponds to points awarded to the developer's performance of the task, where the points are value provided to quantify the user's performance. Prior to or with this scoring, the score may be adjusted based on a manager point allocation, at step 405. For example, a manager may further provide additional points to the user's performance of the task based on available points to the manager or afforded to the particular task. This may be done through the interfaces as discussed above where a manager may view their points and other developers' points. This may also be performed by a user interface that adds one or more points for all task a certain type (e.g., completed tasks and/or pending “to be completed” tasks) and allows distribution of such points. These points may be awarded for highly valued performance and/or based on contributions of one or more users, including combined developer performances where multiple developers work on a project. At step 408, points are provided to a user profile for the developer based on the scoring of the performance by the developer. The user profile may accrue the points, and may further include rewards provided to the developer, such as digital badges that acknowledge the developer's contributions and/or point totals. After step 408, an optional step 409 may allow the developer to transfer points to other users. The developer may transfer to other users an amount of points to acknowledge the other users' help with the performance and/or to otherwise reward the other user.

At step 410, a badge of the user profile is determined based on the points in the user profile. The badge may correspond to a reward that functions as a reward for an amount of points and/or completion of a particular task. The badge may be specifically generated for the points, developer, and/or task, or may be a general badge taken from stock badges awarded to certain milestones or tasks. Further, a stock badge may be customized for a particular user, such as by adding a user's name, the user's employer, the particular task, or other data to the badge. A digital icon representing the badge is then generated for the user profile, at step 412, wherein the digital icon corresponds to a digital graphic or other digital object that can be added to, stored with, and present using the developer's profile. Once this digital icon is generated, the digital icon is provided on a profile platform, at step 414. This may include adding the digital icon to the developer's profile so that other users, including developers, managers, or employers, may view the user's accrued badges and points. Additionally, other rewards may also be provided to a user, including redeeming badges and points for benefits, discounts, and/or employment rewards.

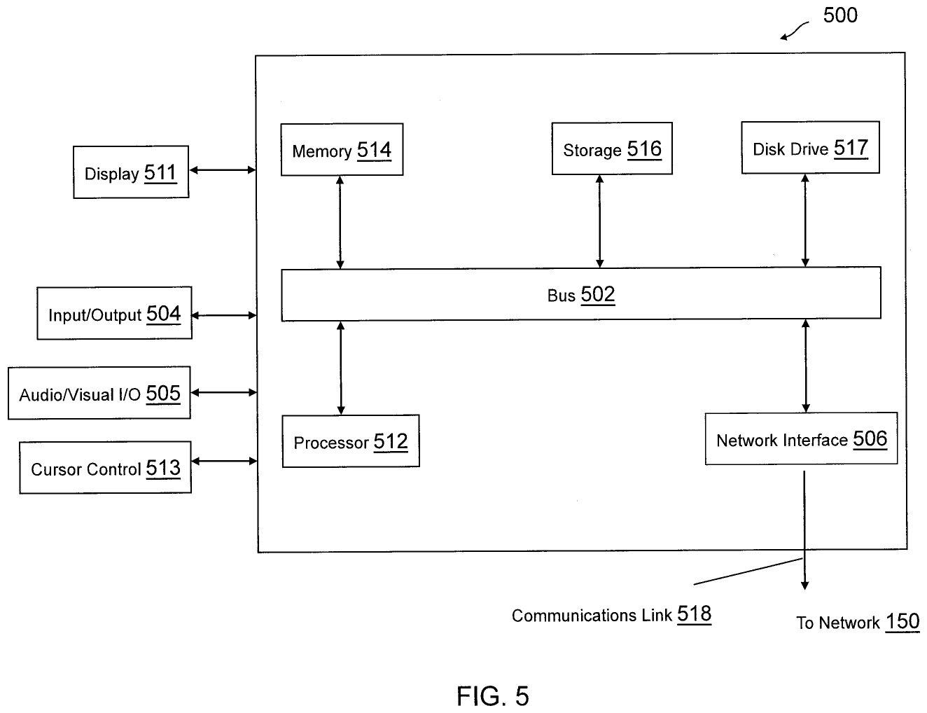

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A service provider system comprising:
a non-transitory memory; and
one or more hardware processors coupled to the non-transitory memory and configured to read instructions from the non-transitory memory to cause the service provider system to perform operations comprising:
detecting a completion of a developer task on at least one of a plurality of developer platforms by a first user with a data coding system associated with the service provider system, wherein the developer task comprises at least one operation performed by the first user with the data coding system;
determining a first task score for the completion of the developer task using a task scoring engine of the service provider system and a plurality of task scoring rules for the at least one of the plurality of developer platforms;
determining a first developer score for the first user based on the first task score and a developer profile for the first user; and
updating a profile score for the developer profile based on the first developer score.

2. The service provider system of claim 1, wherein the determining the first task score comprises scoring the completion of the developer task based on a time to completion of the developer task, a process for completion of the developer task, and the plurality of task scoring rules.

3. The service provider system of claim 2, wherein the plurality of task scoring rules comprises at least one of a task quality completion rule, a completion timeliness rule, a task automation rule, an available instructions rule, a task difficulty rule, or an available users rule.

4. The service provider system of claim 1, wherein the operations further comprise:
generating a graphical icon for the first user based on the first developer score, wherein the graphical icon comprises a digital badge for the developer profile; and
posting the graphical icon to an online user interface associated with the developer profile.

5. The service provider system of claim 4, wherein the operations further comprise:
receiving an allocation request of an additional score amount to the first user for the developer task from a task manager of the first user,
wherein the generating the graphical icon is further based on the additional score amount.

6. The service provider system of claim 4, wherein the digital badge comprises an image associated with one of a total score for the first developer score or a recognition of the completion of the developer task.

7. The service provider system of claim 4, wherein the generating the graphical icon comprises customizing one of a plurality of stock graphical icons based on the first developer score, and wherein the graphical icon comprises an identifier associated with at least one of the first user or the developer task.

8. The service provider system of claim 1, wherein the developer task comprises one of an engineering practice, a software coding process, an innovation task, a self-development task, or an organizational contribution task.

9. The service provider system of claim 1, wherein the detecting the completion of the developer task comprises:
receiving a notification of the completion from one of the first user, an internal review process, or the at least one of the plurality of developer platforms; and
determining task data for the completion of the developer task from at least one of the internal review process or the at least one of the plurality of developer platforms.

10. The service provider system of claim 1, wherein the determining the first task score further comprises comparing the completion of the developer task by the first user to a completion of the developer task by a plurality of additional users based on task performance metrics for a computing platform providing the developer task.

11. A method comprising:
scraping project performance data associated with a software development project for a computing framework of a service provider from a computing device of a user working on a performance of the software development project;
accessing project scoring factors for a project scoring engine of the service provider, wherein the project scoring factors are associated with the performance of the software development project by the user;
determining a project performance score for the performance of the software development project by the user based on the project performance data and the project scoring factors; and
updating a digital profile for the user with an online platform of the service provider based on the project performance score.

12. The method of claim 11, wherein the project scoring factors comprise configurable data metrics associated with user performance of the software development project on a computing platform, and wherein the determining the project performance score is further based on comparing the project performance data to a plurality of performances of the software development project by a plurality of other users.

13. The method of claim 11, wherein the receiving the project performance data comprises pulling that project performance data from a service provider server that provides one or more operations for the performance of the software development project.

14. The method of claim 11, further comprising:
receiving a request to transaction an amount of points in a scoring system associated with the project scoring engine to at least one other digital profile; and
transferring the amount of the points from the digital profile of the user to the at least one other digital profile.

15. The method of claim 11, further comprising:
receiving a request to allocate an amount of points in a scoring system associated with the project scoring engine to the digital profile of the user from a manager account of a manager associated with one of the user or the software development project; and
updating the digital profile with the amount of the points.

16. The method of claim 11, wherein the updating the digital profile comprises allocating an amount of points corresponding to the project performance score to the digital profile, and wherein the method further comprises:
providing a user interface for the digital profile to a computing device of the user, wherein the user interface comprises at least one process for requesting a digital badge based on the points available to the digital profile.

17. A non-transitory machine-readable medium having stored thereon machine-readable instructions executable to cause a machine to perform operations comprising:
receiving, by a service provider, a completion notification of a software coding task performed by a user on an external online platform, wherein the software coding task is associated with the service provider;
pulling, by the service provider from the external online platform, task performance data for the software coding task performed by the user, wherein the task performance data comprises at least one process completed by the user on the external online platform;
scoring, by the service provider using a rules engine, the task performance data for the user based on a plurality of task performance rules for the rules engine;
determining, by the service provider, a digital reward for the user based on the scoring, wherein the digital reward comprises at least a graphical image provided to a user profile for the user with the service provider; and
updating the user profile based on the digital reward.

18. The non-transitory machine-readable medium of claim 17, wherein the completion notification is received from one of the user, a manager of the user, or an external platform based on the at least one process completed by the user on the external online platform.

19. The non-transitory machine-readable medium of claim 17, wherein the operations further comprise:
providing additional scoring points to the scoring of the task performance data from available scoring points to a manager of the software coding task, wherein the available scoring points to the manager are limited based on at least one of a time frame, a software coding task, or the manager.

20. The non-transitory machine-readable medium of claim 17, wherein the digital reward is based on an amount of scoring points determined from the scoring the task performance data, and wherein the at least the graphical image of the digital reward is customized for the user based on at least one of the amount of the scoring points, the user, or the software coding task.
